(19) United States
(12) Patent Application Publication
(10) Pub. No.: US 2016/0140907 A1
(43) Pub. Date: May 19, 2016

(54) Display Apparatus

(71) Applicant: SAKAI DISPLAY PRODUCTS CORPORATION, Osaka (JP)

(72) Inventor: Yukihide Kohtoku, Sakai-shi, Osaka (JP)

(73) Assignee: Sakai Display Products Corporation, Sakai-shi, Osaka (JP)

(21) Appl. No.: 14/897,531

(22) PCT Filed: Jan. 22, 2014
(86) PCT No.: PCT/JP2014/051287

§ 371 Date: Dec. 10, 2015

(51) Int. Cl. G09G 3/34

(52) U.S. Cl. CPC G09G 3/342; G09G 2330/021; G09G 2354/00; G09G 2360/148; G09G 2380/14

(57) ABSTRACT

Provided is a display apparatus which allows a user to easily confirm contents of an image during displaying, when a cover covering a display region is present, even without removing the cover.

The display apparatus having a pixel region including a plurality of pixels controls to, by a display control unit, determine whether the cover covering a central part of the pixel region, or a cover covering a region of a prescribed ratio or more is present, stop the display of the image if it is determined that the cover covering the central part, or the cover covering the region of the prescribed ratio or more is present, and display the entirety of the image within a range which is not covered other than the above-described condition.

This application is the national phase under 35 U.S.C. §371 of PCT International Application No. PCT/JP2014/051287 which has an International filing date of Jan. 22, 2014 and designated the United States of America.

### BACKGROUND OF THE INVENTION

1. Field of the Invention

The present invention relates to a display apparatus which has a pixel region including a plurality of pixels, and to a display apparatus which appropriately controls the display, when a cover covering a pixel region is present.

2. Description of Related Art

Techniques of display panels have advanced, and pixel region in equipment having a display unit has been expanded. Further, the number of equipment which are configured such that the display unit also plays a role of an operation unit (user interface) by embedding a touch panel in a display panel, and which allows a user to intuitively operate by interacting with an image such as an icon displayed on the display panel is increasing. However, there are a variety of problems regarding display control in the equipment having the above-described display unit. A portable equipment has a configuration in which the display unit also plays a role of the operation unit, and in order to increase an area of the pixel region, a portion for holding the equipment is decreased, which may lead to an erroneous operation in some cases. An invention is disclosed in which, when a hold of the display unit of the equipment is detected, the display region is changed within the pixel region so as to exclude the position held by the user.

In addition thereto, as an example of the portable equipment having the display unit, a tablet type personal computer (PC) has been widely distributed. The tablet type PC uses a large portion in a broad surface of a housing formed in a flat plate shape as a display surface. By further technical advancement, a sheet-shaped PC using a flexible display panel may also become to be distributed. In the equipment decreasing in thickness, it is possible to apply a change in the display region within the pixel region. Further, in the equipment that has the display unit decreasing in thickness, it is possible to perform display control so as to prevent a deterioration in visibility due to the reflection of strong environmental light.

### SUMMARY OF THE INVENTION

In some cases, the display apparatus, specifically, the equipment that has the display unit decreasing in thickness is treated as a booklet such as a book, notebook or pocketbook, or a stationery such as papers or files which are made of a paper medium. For example, a thin type display apparatus is placed on a desk with the display surface thereof disposed upward, or is juxtaposed on a shelf together with a booklet. In particular, when the display apparatus is placed on the desk, another paper medium, sheet, or the like is further placed on the display apparatus, thereby covering a part or an entirety of the pixel region. In order to confirm contents of the image displayed on the pixel region, it is necessary for the user to remove the object placed thereon.

In addition, when observing the contents from only an exposed part of the pixel region, the user may misidentify the contents. In order to improve the convenience of the display apparatus, it is preferable that the user confirms easily the contents of the image during displaying, even without removing the cover.

The conventional invention is intended to detect the hold by the fingers of the user, or is intended to improve the deterioration in visibility due to reflection of strong outdoor environmental light. Therefore, since the case of presenting the cover is not assumed in all the patent documents, there has been no comprehensive solution to solve the problems which occur when the cover is present.

The present invention has been made in view of the circumstances described above, and aims to provide a display apparatus which can achieve power conserving, without misidentification of the display contents by a user, when a cover covering a pixel region is present.

According to an aspect of the invention, when a cover covering the central part or a portion of a prescribed ratio or more of the pixel region of a flat plate-shaped display apparatus is present, the display itself of an image is stopped. That is, it is determined not only simply whether the cover is present, but also whether the central part is covered, or an area of the pixel region covered by the cover is as wide as a prescribed ratio or more. When the central part is covered, or the area of the pixel region covered by the cover is wide, even if the image is displayed by the pixels of the remaining part which is not covered, difficulty in viewing of the image is highly likely to occur. Therefore, by preventing the display itself, it is possible to achieve the appropriate display of the image and power conserving.

According to another aspect of the invention, the presence or absence of the cover is determined based on the received light amount in the light receiving sensor provided at the central part in the pixel region. If the central part is covered, difficulty in viewing of the image is estimated. Therefore, by preventing the display itself, it is possible to achieve the appropriate display of the image and power conserving.

According to another aspect of the invention, the presence or absence of the cover is determined based on the received light amount in the plurality of light receiving sensors disposed at positions different from each other in the pixel region. Even if the light receiving sensors are disposed in the pixel region, it is possible to achieve the determination of the presence or absence of the cover by a simple configuration, without unnecessarily decreasing the display quality of the image. By preventing the display itself, it is possible to achieve the appropriate display of the image and power conserving.

According to the aspect of the invention, the light receiving sensors may be juxtaposed in a lattice shape within the pixel region, and thereby it is possible to specify the range covered by the cover in detail, and appropriately determine whether to stop the image display.

According to the aspect of the invention, when the image display by the pixels of the pixel region is achieved by a transmissive liquid crystal panel and a light source device for the liquid crystal panel, the amount of light in the entirety of the pixel region may be decreased during stopping the display. Thereby, it is possible to achieve the appropriate display of the image and power conserving.

According to the present invention, if the cover covering the central part or the portion of the prescribed ratio or more of the pixel region is present, the display itself of the image is stopped, and thereby it is possible to achieve the appropriate display of the image and power conserving, without misidentification of the display contents by a user.

### BRIEF DESCRIPTION OF THE DRAWINGS

FIG. 1 is an explanatory view illustrating an outline of the present invention.

FIG. 2 is a block diagram illustrating a configuration of an information processing apparatus according to Embodiment 1.

FIG. 3 is an explanatory view schematically illustrating an arrangement example of a plurality of light sources in a light source device of Embodiment 1.

FIG. 4 is an explanatory view illustrating a light receiving sensor of Embodiment 1.

FIG. 5 is an explanatory view schematically illustrating an arrangement of the light receiving sensors according to Embodiment 1.

FIG. 6 is a functional block diagram illustrating functions achieved by a display control unit according to Embodiment 1.

FIG. 7 is a flow chart illustrating an example of a processing procedure executed by the display control unit according to Embodiment 1.

FIG. 8 is a flow chart illustrating an example of a procedure of received light amount determination processing.

FIG. 9 is an explanatory view of a display example according to Embodiment 1 when a cover is present on a display unit.

FIG. 10 is an explanatory view of another display example according to Embodiment 1 when the cover is present on the display unit.

FIG. 11 is an explanatory view of another display example according to Embodiment 1 when the cover is present on the display unit.

FIG. 12 is a flow chart illustrating another example of the procedure of the received light amount determination processing according to Embodiment 1.

FIG. 13 is an explanatory view schematically illustrating an arrangement of a light receiving sensor according to Embodiment 2.

FIG. 14 is a functional block diagram illustrating functions achieved by a display control unit according to Embodiment 2.

FIG. 15 is a flow chart illustrating an example of a processing procedure executed by the display control unit according to Embodiment 2.

FIG. 16 is an explanatory view schematically illustrating an arrangement example of a plurality of light receiving sensors according to Embodiment 3.

FIG. 17 is a functional block diagram illustrating functions achieved by a display control unit according to Embodiment 3.

FIG. 18 is a flow chart illustrating an example of a processing procedure executed by the display control unit according to Embodiment 3.

### DESCRIPTION OF THE PREFERRED EMBODIMENTS

Hereinafter, embodiments of the present invention will be described in detail with reference to the accompanying drawings.

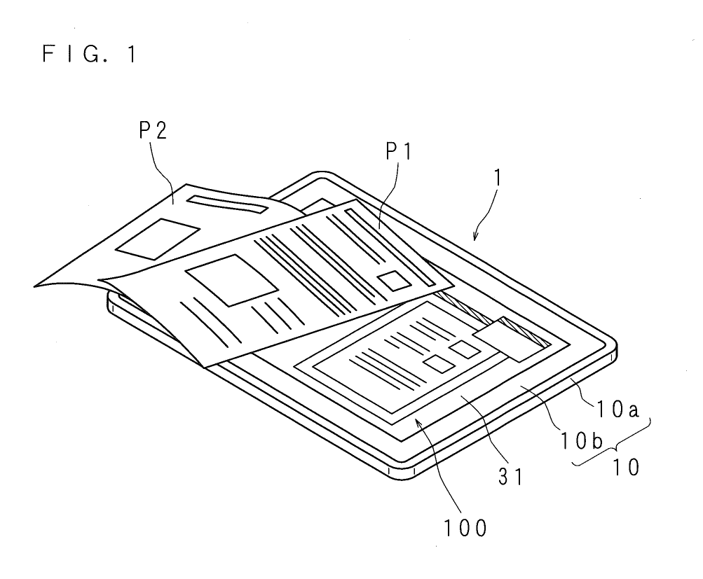

FIG. 1 is an explanatory view illustrating an outline of the present invention. An information processing apparatus 1 is a tablet type PC to which the present invention is applied. The information processing apparatus 1 displays an image on a display unit 100. The explanatory view of FIG. 1 illustrates a state in which the information processing apparatus 1 is placed with a surface of the display unit 100 disposed upward. Further, papers P1 and P2 are placed so as to cover a part of the surface of the display unit 100. Thereby, the image displayed on the part of the surface of the display unit 100 is covered, and is difficult to be viewed. When a part of the surface of the display unit 100 is covered as illustrated in FIG. 1, the image displayed on the display unit 100 is displayed in the remaining part other than the covered part, or otherwise, when most of the surface is covered to the extent that viewing is difficult, display of the image is stopped. Thereby, misidentification of display contents from only a part of the image by a user may be prevented, and energy conserving may be achieved. Hereinafter, each configuration for achieving a display control in the display unit 100 will be described in detail.

### Embodiment 1

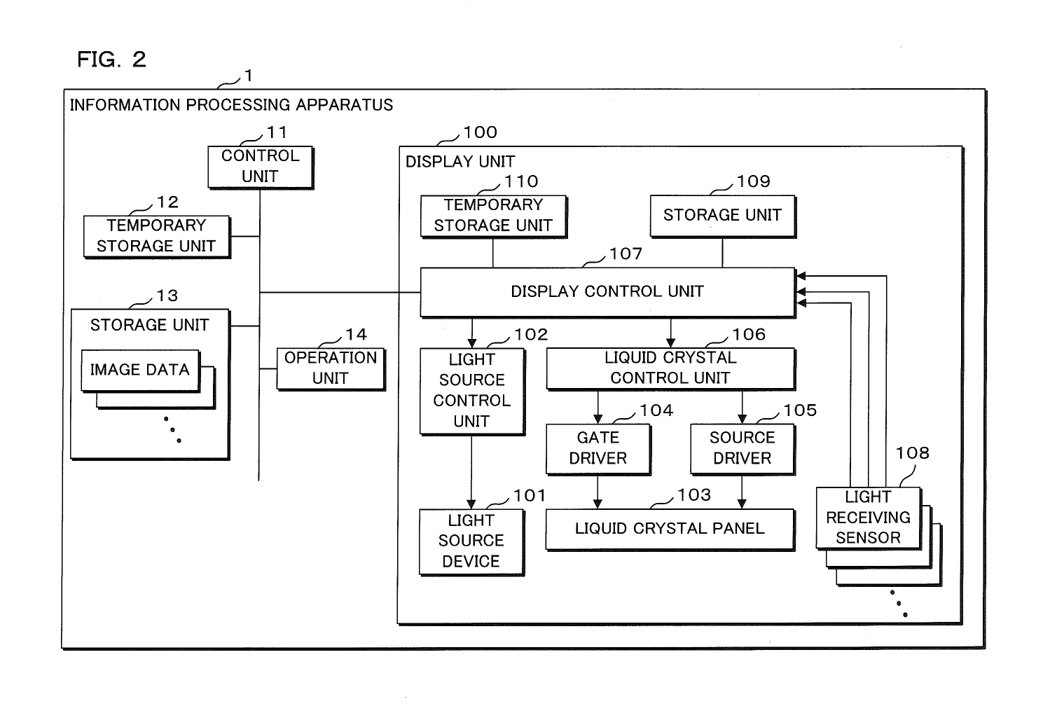

FIG. 2 is a block diagram illustrating a configuration of the information processing apparatus 1 according to Embodiment 1. The information processing apparatus 1 includes a control unit 11, a temporary storage unit 12, a storage unit 13, an operation unit 14, and the display unit 100, which are housed in a housing 10.

The control unit 11 uses a central processing unit (CPU). The control unit 11 allows the tablet type PC to function as the information processing apparatus 1, by reading and executing a computer program (not illustrated) stored in the storage unit 13.

The temporary storage unit 12 uses a RAM such as a dynamic random access memory (DRAM), a synchronous DRAM (SDRAM) or the like. The temporary storage unit 12 stores temporarily information generated by the processing of the control unit 11. The storage unit 13 uses a flash memory. The storage unit 13 is stored with a plurality of data of the images to be displayed on the display unit 100 other than the computer program read by the control unit 11. Further, the storage unit 13 may use a storage device in addition to the flash memory.

The operation unit 14 uses the touch panel embedded in the display unit 100, and a button group (not illustrated) included in the housing 10. The operation unit 14 notifies the control unit 11 of the presence or absence of a contact on the touch panel by the user, and positional information of the contact position. In addition, the operation unit 14 notifies the control unit 11 of information such as the pressing of the button, pressing time and the like.

The control unit 11 outputs image data stored in the storage unit 13 to the display unit 100 based on the operation by the user which is detected by the operation unit 14, to display the image on the display unit 100.

The display unit 100 includes a light source device 101, a light source control unit 102, a liquid crystal panel 103, a gate driver 104, a source driver 105, a liquid crystal control unit 106, a display control unit 107, light receiving sensors 108, a storage unit 109, and a temporary storage unit 110.

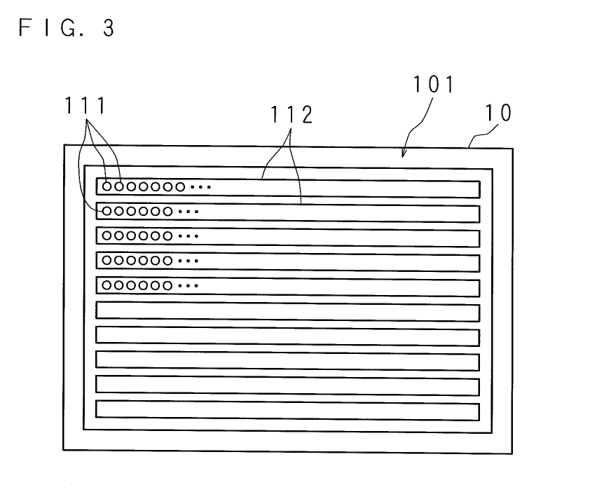

The light source device 101 includes a plurality of light sources 111 arranged on a bottom of a chassis 10a of the housing 10 (see FIG. 3), control circuits for each of the light sources 111 and an optical sheet (not illustrated). The light sources 111 use, for example, a light emitting diode (LED), and are juxtaposed on the bottom of the chassis 10a in a lattice shape. The light source device 101 controls the turn on/off, and contrast of each of the plurality of light sources 111 by the control circuits, based on a control signal from the light source control unit 102. The light source control unit 102 is a circuit configured to generate the control signal for controlling the turn on/off, and contrast of each of the plurality of light sources 111, based on the light source control signal from the display control unit 107, and output the generated signal to the light source device 101.

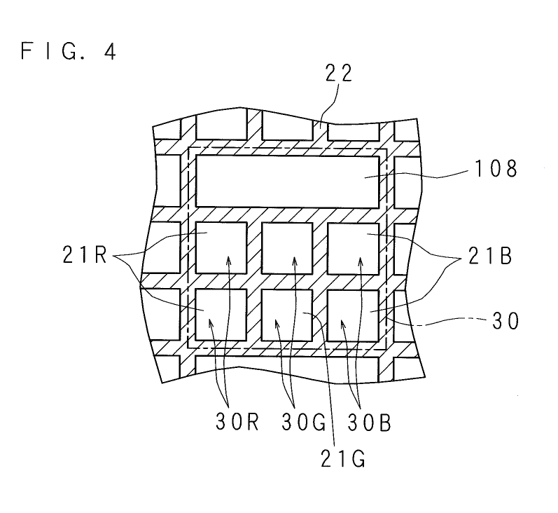

The liquid crystal panel 103 is a rectangular display panel, and employs an active matrix type. The liquid crystal panel 103 includes respective elements such as a color filter, an electrode, an electrode for driving liquid crystal, and a transistor and auxiliary capacitor connected to the electrodes, which are respectively formed on a pair of transparent rectangular substrates, and is configured in such a manner that two substrates are bonded so as to face each other, and a liquid crystal material containing liquid crystal molecules is injected into a space formed between the substrates. The liquid crystal panel 103 has a pixel region 31 in which a plurality of pixels 30 (see FIG. 4) for achieving the image display are arranged in the lattice shape. The electrodes of each substrate are juxtaposed so as to correspond to the respective pixels 30 within the pixel region 31. The respective pixels 30 include two sub-pixels 30R and 30R, 30G and 30G, and 30B and 30B for a plurality of different colors (R (red), G (green), and B (blue)), and the respective electrodes are arranged so as to correspond to the sub-pixels. An electrode (a pixel electrode) on one substrate is connected with a thin film transistor (TFT) and the auxiliary capacitor. Source bus lines, gate bus lines and auxiliary capacitance bus lines are formed on the substrate to respectively supply a voltage signal to a source electrode and a gate electrode of the thin film transistor, and the other electrode of the auxiliary capacitor.

The gate driver 104 is connected to the gate bus line. The gate driver 104 outputs a gate signal to the gate electrode of the thin film transistor which is connected to the pixel electrode, to control the turn on/off of the thin film transistor. The source driver 105 is connected to the source bus line. The source driver 105 outputs a source signal to the source electrode of the thin film transistor which is connected to the pixel electrode, to control the electric field strength applied to a liquid crystal layer. The liquid crystal control unit 106 outputs the control signal to the gate driver 104 and the source driver 105, based on the image signal applied from the display control unit 107. By this, the transmission amount of light in the liquid crystal layers corresponding to the respective sub-pixels 30R and 30R, 30G and 30G, and 30B and 30B is controlled, and thereby the image display which finely represents gradation of the color and brightness of the respective pixels 30 in the pixel region 31 may be achieved.

The display control unit 107 uses a graphics processing unit (GPU). The display control unit 107 outputs the image signal to the liquid crystal control unit 106 and outputs a light source control signal to the light source control unit 102, based on the image data applied from the control unit 11. In addition, the display control unit 107 determines whether the cover covering the pixel region 31 is present, based on the data from the light receiving sensors 108 or the data from other sensors, and controls to display the image depending on the presence or absence of the cover.

The light receiving sensor 108 uses an optical element such as a photodiode, a phototransistor, or a photoresistor. The light receiving sensor 108 outputs electrical information depending on an amount of received light. The display control unit 107 is adapted so as to receive the information from the light receiving sensors 108. The light receiving sensors 108 are provided at plurality of positions on the pixel region 31. In Embodiment 1, one or a plurality of the light receiving sensors 108 are provided in the respective pixels 30. Further, one light receiving sensor 108 may be provided in each pixel group (for example, 8×8 pixels, or 10×10 pixels, etc.) including a plurality of pixels 30, or may be provided at four corners and a center of the pixel region 31, respectively.

The storage unit 109 uses the flash memory, and may also use various ROMs. The storage unit 109 is stored with a control program read by the display control unit 107. The storage unit 109 is stored with a value (a prescribed value or prescribed ratio, etc.) that functions as one of a variety of determination criteria referred to by the display control unit 107, or various information such as positional information for each of the plurality of the light receiving sensors 108. The value that functions as the determination criteria may be rewritten according to an instruction from the control unit 11 through the display control unit 107, and the display control unit 107 may change the value that functions as the determination criteria depending on environmental light. The temporary storage unit 110 uses a RAM such as a DRAM or a SDRAM. The temporary storage unit 110 is temporarily stored with information generated by the processing of the display control unit 107.

Hereinafter, in the display unit 100 having the above-described configuration, a control for displaying an image in the remaining part which is not covered by the cover when the cover is present on the pixel region 31 during displaying the image on the pixel region 31 based on the image data applied from the control unit 11 by the display control unit 107 will be described.

FIG. 3 is an explanatory view schematically illustrating an arrangement example of the plurality of light sources 111 in the light source device 101 of Embodiment 1. FIG. 3 illustrates an arrangement of the respective light sources 111 as viewing the light source device 101 from an opening part of the chassis 10a on which the plurality of light sources 111 are installed. The light sources 111 are juxtaposed on an elongated substrate 112 in a long-side direction thereof. A plurality of substrates 112 are juxtaposed in a short-side direction so as to be laid in the long-side direction of the housing 10 of the information processing apparatus 1, such that the plurality of light sources 111 are juxtaposed in the lattice shape. In addition, the substrates 112 include control circuits (not illustrated) formed thereon to control the turn on/off, and contrast of each of the light sources 111, based on the control signal from the light source control unit 102. Further, the arrangement of the plurality of light sources 111 is not limited thereto. For example, the plurality of light sources 111 may be disposed in a staggered lattice shape or a zigzag shape, so that the positions thereof are shifted for each row or for a plurality rows.

FIG. 4 is an explanatory view illustrating the light receiving sensor 108 of Embodiment 1. FIG. 4 is an enlarged view of a substrate facing the substrate on which the pixel electrode is provided. As illustrated in FIG. 4, color filters 21R, 21G and 21B of respective colors of RGB, and a black matrix 22 made of a resin film using carbon black, etc. are formed on the substrate. Further, the light receiving sensor 108 is disposed on the substrate. In Embodiment 1, one pixel 30 includes six sub-pixels 30R and 30R, 30G and 30G, and 30B and 30B, which are formed by being disposed in the lattice shape of two rows and three columns. One light receiving sensor 108 is provided in each pixel 30 so as to be laterally extended over three columns above the sub-pixels 30R and 30R, 30G and 30G, and 30B and 30B. Of course, the light receiving sensor 108 is not limited to the configuration provided as illustrated in FIG. 4. The light receiving sensor 108 may be provided so as to be arranged on the black matrix 22 in the lattice shape by one for each group of the plurality of pixels 30, in order to suppress a decrease in an amount of light.

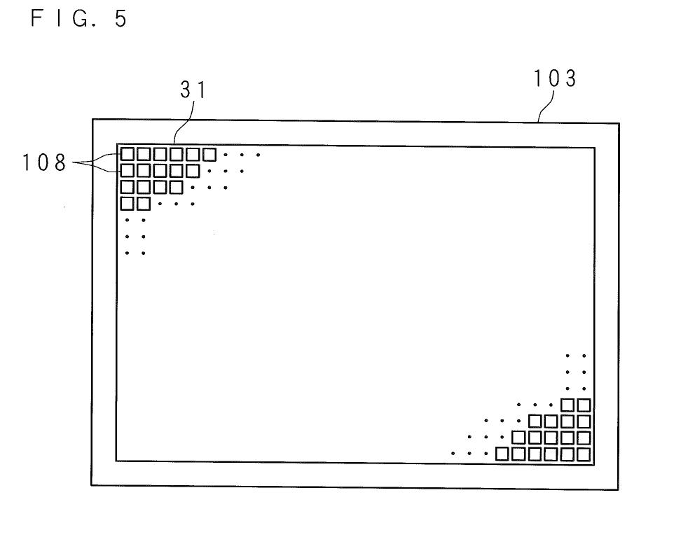

FIG. 5 is an explanatory view schematically illustrating an arrangement of the light receiving sensors 108 according to Embodiment 1. FIG. 5 illustrates a front of the liquid crystal panel 103. As illustrated in FIG. 5, the light receiving sensors 108 are juxtaposed on the pixel region 31 in the lattice shape. The positions of each of the plurality of pixels 30 are specified by coordinates (v: vertical and h: horizontal) in a longitudinal direction (lines) and a lateral direction, and the positions of the light receiving sensors 108 are also specified by (v, h)=(m, n) (m=0, 1 and . . . , and n=0, 1 and . . . ) so as to correspond to the positions of the pixels 30. In this regard, the storage unit 109 is stored with information on the positions (v and h) of the light receiving sensors 108 in association with each of the plurality of the light receiving sensors 108, and the display control unit 107 may obtain received light amount data for each of the light receiving sensors 108 by specifying the positions of the light receiving sensors 108.

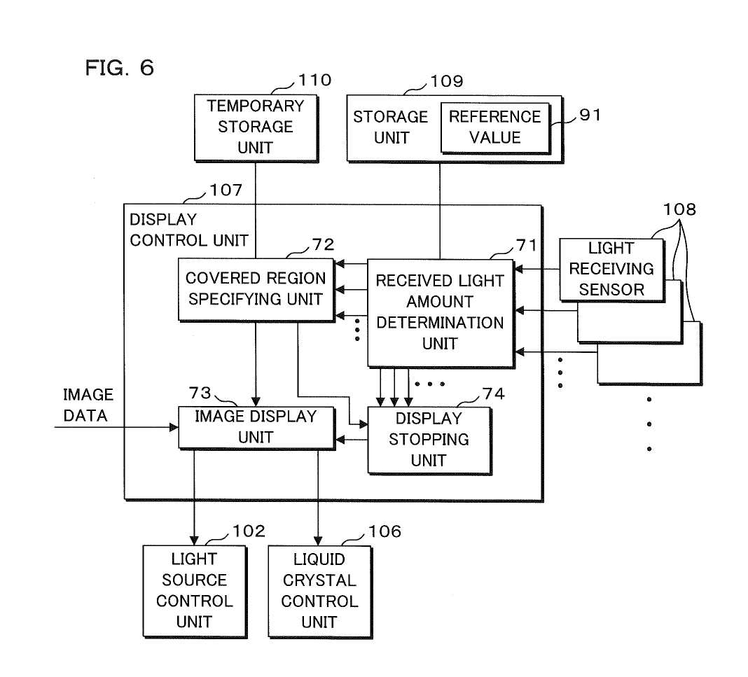

The display control unit 107 controls to display an image depending on the presence or absence of the cover covering the pixel region 31, based on the received light amount data respectively obtained from the light receiving sensors 108 disposed as illustrated in FIG. 5. FIG. 6 is a functional block diagram illustrating functions achieved by the display control unit 107 according to Embodiment 1. The display control unit 107 functions as a received light amount determination unit 71, a covered region specifying unit (specifying unit) 72, an image display unit 73, and a display stopping unit 74.

The received light amount determination unit 71 respectively receives the received light amount data from the plurality of the light receiving sensors 108, determines whether the received light amount in each light receiving sensor 108 is a reference value (a first prescribed value) 91 or less within a plurality of prescribed values stored in the storage unit 109, and outputs the determined result. In Embodiment 1, the received light amount determination unit 71 determines whether the received light amount is the reference value 91 or less for each light receiving sensor 108 provided in the respective pixels 30, and outputs the determined result.

The covered region specifying unit 72 specifies a covered region (or the remaining part) covered by the cover, based on the determined result of the received light amount determination unit 71 for the received light amount in each light receiving sensor 108 and the position of each light receiving sensor 108, and obtains coordinate information for the pixel region 31. Specifically, the covered region specifying unit 72 specifies the covered region or the remaining part as the cover is present, only when it is determined that the determined result for the received light amount in the plurality of pixels 30 over a continuously extending surface shape is the reference value 91 or less. That is, even if it is determined that the received light amount in the plurality of the light receiving sensors 108 is the reference value 91 or less, when the corresponding pixels 30 are not formed in a continuous surface shape, the covered region specifying unit 72 determines that the cover is not present, and does not specify the covered region or the remaining part. In addition, the covered region specifying unit 72 may be configured to determine whether an outline of the shape of the specified covered region includes a linear outline, or whether the covered region includes an outer edge of the pixel region 31, so that it is possible to accurately determine the presence or absence of the cover.

The image display unit 73 determines a display region for displaying an image on the basis of the image data applied from the control unit 11, based on the coordinate information of the covered region specified by the covered region specifying unit 72. The image display unit 73 generates an image signal so as to display the image in the determined display region, generates the light source control signal so as to decrease the amount of light of the covered region or the amount of light of the region outside the display region, and outputs the generated signals to the liquid crystal control unit 106 and the light source control unit 102, respectively. In addition, if it is determined that the display is to be stopped by the processing of the display stopping unit 74, the image display unit 73 outputs the light source control signal for turning off or darkening the light sources 111. If it is determined that the display is to be stopped by the display stopping unit 74, the image display unit 73 may stop the output of the image signal.

The display stopping unit 74 determines whether to stop the display, based on the determined result of the received light amount determination unit 71 for the received light amount in each light receiving sensor 108 and the position of each light receiving sensor 108. Specifically, when the positional information is stored in the temporary storage unit 110, and a ratio occupied by the remaining part other than the range (the covered region) corresponding to a positional information group to the pixel region 31 is as low as a prescribed ratio (a second prescribed ratio) or less, the display stopping unit 74 stops the display itself. As the prescribed ratio, an appropriate ratio is set in advance, for example, 20%, 10%, . . . and the like. Of course, it is the same as the display stopping unit 74 determining whether a ratio occupied by the area of the covered region to the pixel region 31 is the prescribed ratio or more.

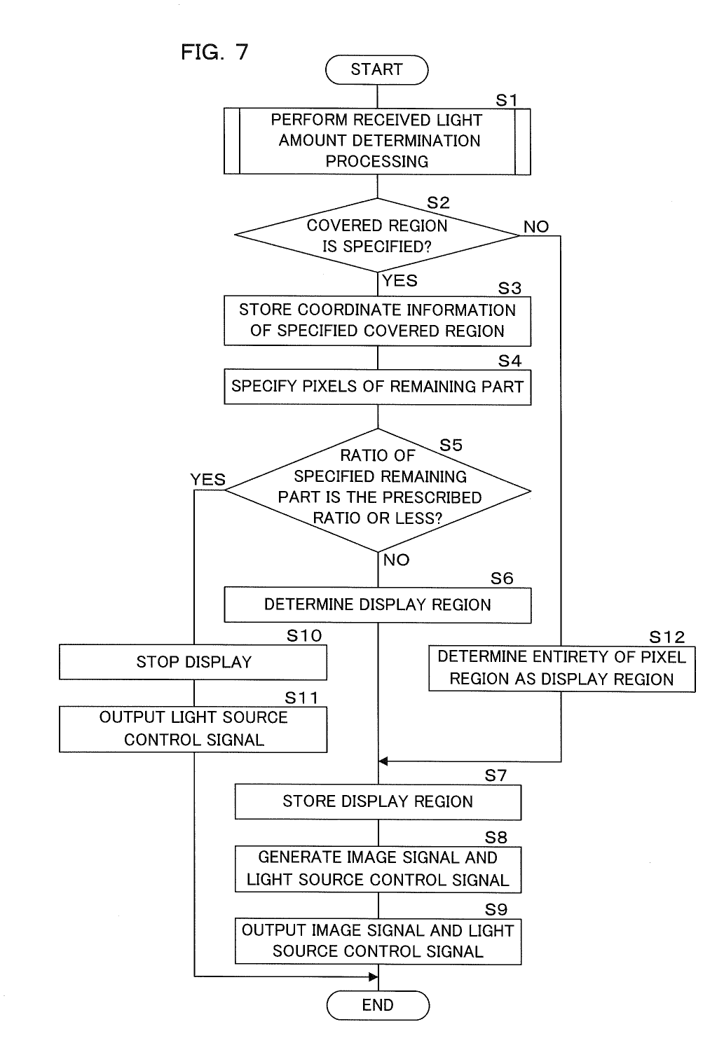

A processing procedure executed by each function of the display control unit 107 will be described with reference to a flow chart. FIG. 7 is a flow chart illustrating an example of the processing procedure executed by the display control unit 107 of Embodiment 1. The display control unit 107 periodically repeats the processing illustrated below at a predetermined time interval such as 500 milliseconds, for example.

The display control unit 107 performs received light amount determination processing (step S1), and thereby, positional information of the light receiving sensors 108 for which it has been determined that the received light amount is the reference value 91 or less is temporarily stored in the temporary storage unit 110.

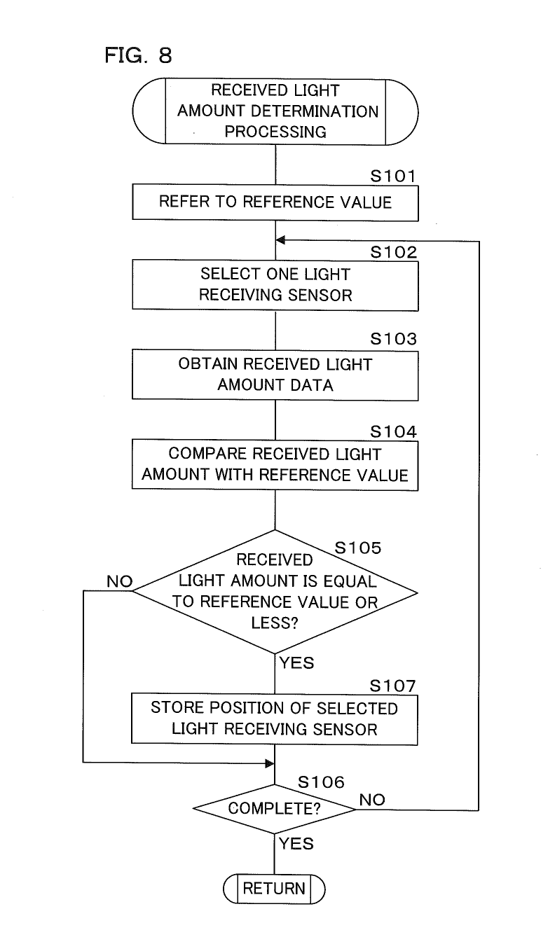

FIG. 8 is a flow chart illustrating an example of a procedure of the received light amount determination processing. The processing procedure illustrated in the flow chart of FIG. 8 corresponds to details of step S1 in the flow chart of FIG. 7.

The display control unit 107 refers to the reference value 91 for the received light amount from the storage unit 109 (step S101). The display control unit 107 selects one light receiving sensor 108 of the plurality of the light receiving sensors 108 (step S102). Further, in Embodiment 1, because the light receiving sensors 108 are provided in the lattice shape similarly to the plurality of pixels 30, the display control unit 107 sequentially specifies and selects the light receiving sensors in an order of (v, h)=(0, 0), (0, 1) and . . . by the coordinates from the light receiving sensor 108 corresponding to the pixel 30 of v=0, and h=0.

The display control unit 107 obtains the received light amount data of the selected light receiving sensor 108 (step S103). The display control unit 107 compares the received light amount obtained based on the obtained received light amount data with the reference value 91 (step S104), and determines whether the received light amount is equal to the reference value 91 or less (step S105). If it is determined that the received light amount is higher than the reference value 91 (NO in S105), the display control unit 107 determines whether the comparison for all the light receiving sensors 108 is completed (step S106). If it is determined that the comparison is not completed (NO in S106), the display control unit 107 returns the processing to step S102, so as to select the next one light receiving sensor 108 from the plurality of the light receiving sensors 108.

In step S105, if it is determined that the received light amount is the reference value 91 or less (YES in S105), the display control unit 107 stores the position (information of (v and h)) of the selected light receiving sensor 108 as the positional information illustrating the covered region in the temporary storage unit 110 (step S107), and progresses the processing to step S106.

In step S106, if it is determined that the comparison is completed (YES in S106), the display control unit 107 returns the processing to step S2 of the flowchart of FIG. 7.

Referring again to FIG. 7, the processing procedure by the display control unit 107 will be further described.

The display control unit 107 determines whether the covered region is specified based on the positional information group stored in the temporary storage unit 110 (step S2). Specifically, in this regard, the display control unit 107 determines whether the positional information group stored in the temporary storage unit 110 corresponds to the position which is a continuation of the surface shape as described above. When the positional information group corresponds to a discontinuous position, and is discrete, the display control unit 107 determines that the covered region is not specified. Further, if it is determined that the covered region is specified, it is determined that the cover is present.

If it is determined that the covered region is specified in step S2 (YES in S2), the display control unit 107 stores the coordinate information of the specified covered region (for example, the coordinate information corresponding to an apex of an appearance of the covered region) in the temporary storage unit 110 (step S3). The display control unit 107 specifies the pixels of the remaining part, based on the coordinate information of the covered region stored in the temporary storage unit 110 (step S4), and determines whether a ratio occupied by the area of the specified remaining part to the pixel region 31 is the prescribed ratio or less (step S5).

In step S5, if it is determined that the occupied ratio is higher than the prescribed ratio (NO in S5), the display control unit 107 determines the display region including a part and/or all of the pixels of the remaining part (step S6). In Embodiment 1, the image display unit 73 determines the display region as a rectangle having the largest area of the rectangles inscribed in the shape of the remaining part. In this regard, the display control unit 107 may determine the display region as a rectangle having an aspect ratio of the same ratio as the aspect ratio of the pixel region 31.

The display control unit 107 stores the display region determined in step S6 in the temporary storage unit 110 (step S7), generates the image signal and the light source control signal, so as to display the image in the display region based on the image data output from the control unit 11 (step S8), outputs the generated signals to the liquid crystal control unit 106 and the light source control unit 102, respectively (step S9), and ends the processing.

In step S5, if it is determined that the occupied ratio is the prescribed ratio or less and the area is small (YES in S5), the display control unit 107 stops the display (step S10), outputs the light source control signal for turning off the light sources 111 (step S11), and ends the processing.

In step S2, if it is determined by the display control unit 107, that the covered region is not specified (NO in S2), the display control unit 107 determines the entirety of the pixel region 31 as the display region (step S12), and progresses the processing to step S7.

Thereafter, until the processing from steps S1 to S12 are performed, the display control unit 107 continuously generates and outputs the image signal based on the image data output from the control unit 11, so as to display the image in the determined display region.

Further, the determination of step S2 is not essential, and when the received light amount based on the received light amount data obtained from a part of the light receiving sensors 108 is the reference value 91 or less, the processing may progress to step S4 that displays the image in the remaining part.

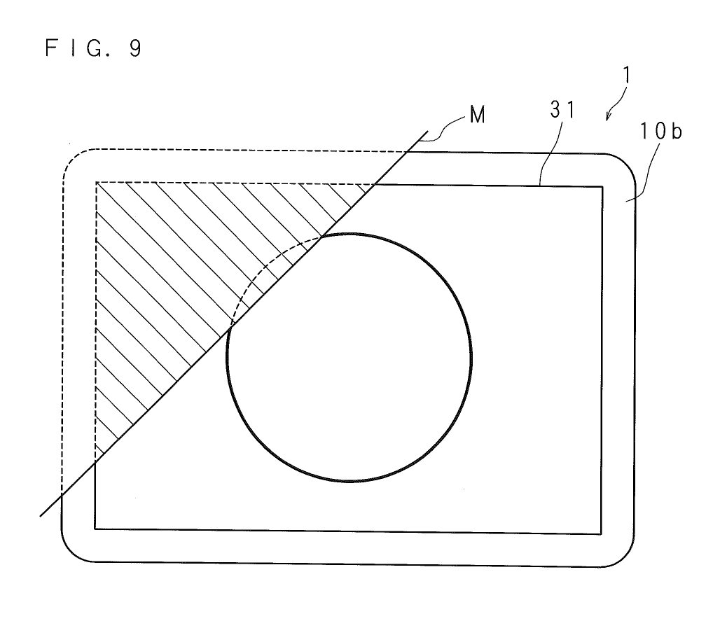

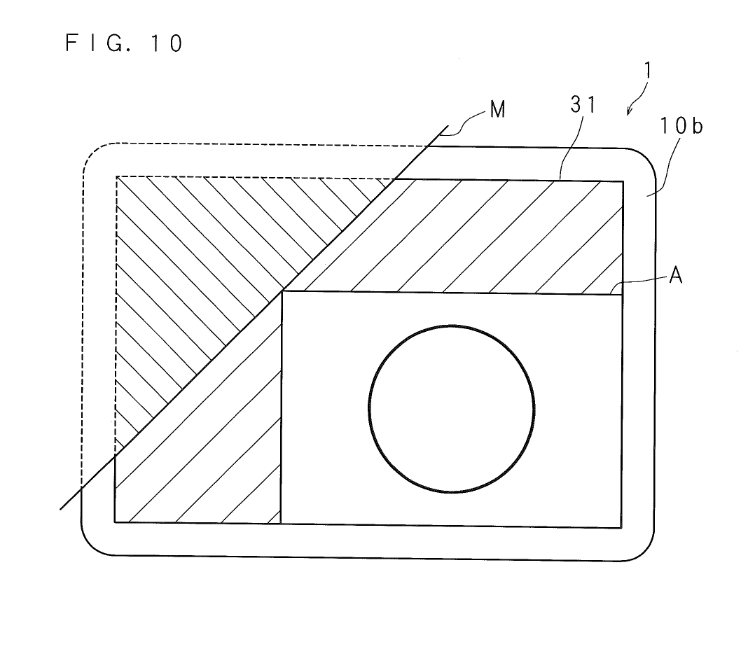

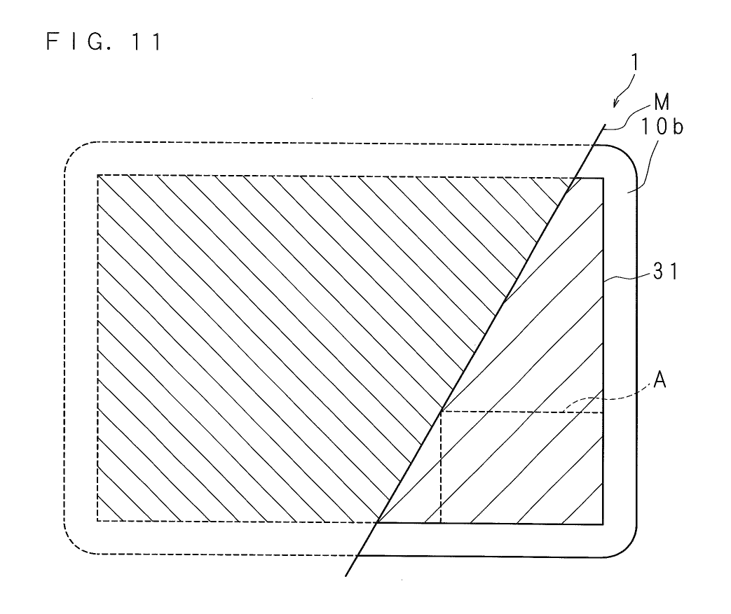

FIGS. 9 to 11 are explanatory views of the display examples according to Embodiment 1 when the cover is present on the display unit 100. FIG. 9 illustrates, as a comparison, a display example when the image is displaying by using the entirety of the pixels of the pixel region 31, and FIGS. 10 and 11 illustrate display examples when it is determined that the covered region is specified by the display control unit 107. Symbols M in FIGS. 9 to 11 denote the covers.

As illustrated in FIG. 9, when the image is displaying by using the entirety of the pixel region 31, if the cover M is placed on the information processing apparatus 1, the cover M covers a part of the display unit 100. Thereby, a part of the pixel region 31 becomes the covered region illustrated by hatching, and a part of the displayed image cannot be viewed. Compared with this, as illustrated in FIG. 10, if it is determined that the covered region is specified, the display region illustrated by symbol A is determined by the processing based on the function of the image display unit 73 of the display control unit 107, and the image is displayed within the display region A so as not to be covered by the cover M. Because the image is displayed so as to avoid the cover M, a user may easily confirm the contents of the image during displaying, even without removing the cover M.

Further, in FIG. 10, nothing is displayed in the regions other than the display region A within the remaining part outside the covered region in the pixel region 31. The corresponding region may be set to be any color such as black or gray. The display control unit 107 may also decrease the amount of light of the light sources 111 located at the corresponding positions, for the regions other than the display region A within the remaining part.

As illustrated in FIG. 11, when the covered region is the prescribed ratio or more, even so as to display the image in the display region A within the remaining part, the display area A is too small, and thus it is sometimes difficult to view the image. In the information processing apparatus 1 of Embodiment 1, since the display control unit 107 stops the display, misidentifying the contents of the image may be prevented. Further, in such a case, since the light sources 111 are turned off, it is possible to achieve the energy conserving by appropriately controlling the display.

The received light amount determination processing in step S1 illustrated in the flow chart of FIG. 7 may be achieved by other methods. For example, the display control unit 107 obtains the received light amount data from selected light receiving sensors 108 by thinning, rather than obtaining that from all the light receiving sensors 108 corresponding to each of the plurality of pixels 30. Specifically, the display control unit 107 selects one light receiving sensor 108 for each block including a group of 16×16 pixels 30 in the pixel region 31, for example, the light receiving sensor 108 corresponding to the center of each block. Thereby, the number of the determinations by the received light amount determination unit 71 is reduced. Further, it may be configured in such a manner that the light receiving sensors 108 are provided for each block of 16 pixels×16 pixels in advance, rather than they are provided corresponding to all the pixels 30. In this case, the region of the pixel region 31 in which the light from the light source device 101 is covered by the light receiving sensor 108 may be reduced, and the amount of light may be maintained at a high brightness.

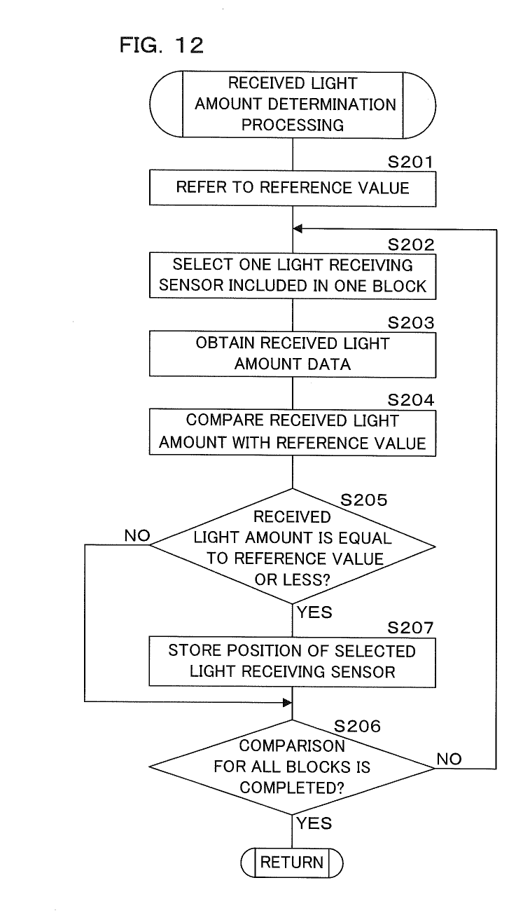

FIG. 12 is a flow chart illustrating another example of the procedure of the received light amount determination processing according to Embodiment 1.

The display control unit 107 refers to the reference value 91 for the received light amount from the storage unit 109 (step S201), and selects one light receiving sensor 108 (step S202).

The display control unit 107 obtains the received light amount data of the selected light receiving sensor 108 (step S203), compares the received light amount obtained based on the obtained received light amount data with the reference value 91 (step S204), and determines whether the received light amount is the reference value 91 or less (step S205). If it is determined that the received light amount is higher than the reference value 91 (NO in S205), the display control unit 107 determines whether the comparison of the light receiving sensor 108 for the all blocks is completed (step S206). If it is determined that the comparison is not completed (NO in S206), the display control unit 107 returns the processing to step S202, so as to select the light receiving sensor of the next block.

In step S205, if it is determined that the received light amount is the reference value 91 or less (YES in S205), the display control unit 107 stores the positional information on the block of the selected light receiving sensor 108 in the temporary storage unit 110 (step S207), and progresses the processing to step S206. In step S206, if it is determined that the comparison is completed (YES in S206), the display control unit 107 returns the processing to step S2 of the flow chart of FIG. 7.

### Embodiment 2

In Embodiment 2, the light receiving sensor 108 is provided at a part (central part) of the pixel region 31, and the presence or absence of the cover is determined based on the received light amount in the light receiving sensor 108 of the part, and when the cover is present, the display is controlled so as to stop the display. Further, the central part referred to herein does not mean only the center in a strict sense, and means the extent of the vicinity of the center.

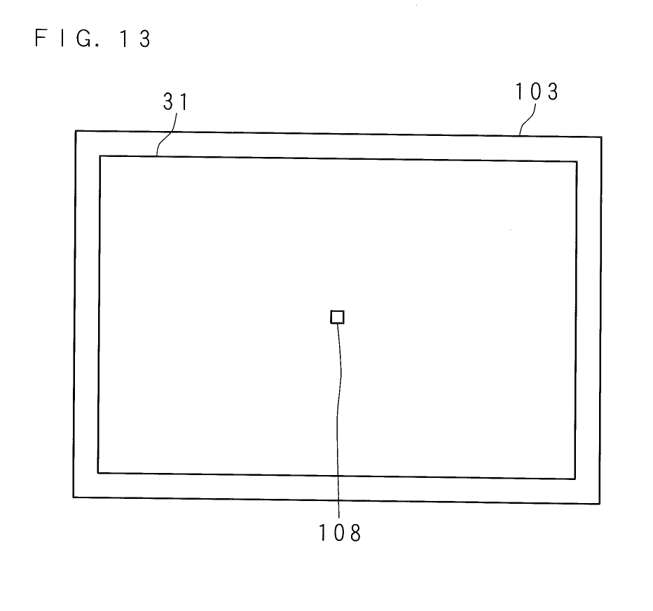

The hardware configuration of an information processing apparatus 1 according to Embodiment 2 is the same as that of the information processing apparatus 1 according to embodiment 1, except the arrangement of a light receiving sensor 108, and therefore, will be denoted by the same reference numerals, and will not be described in detail. FIG. 13 is an explanatory view schematically illustrating an arrangement of the light receiving sensor 108 according to Embodiment 2. FIG. 13 illustrates the front of the liquid crystal panel 103. As illustrated in FIG. 13, only one light receiving sensor 108 is provided at the central part on the pixel region 31.

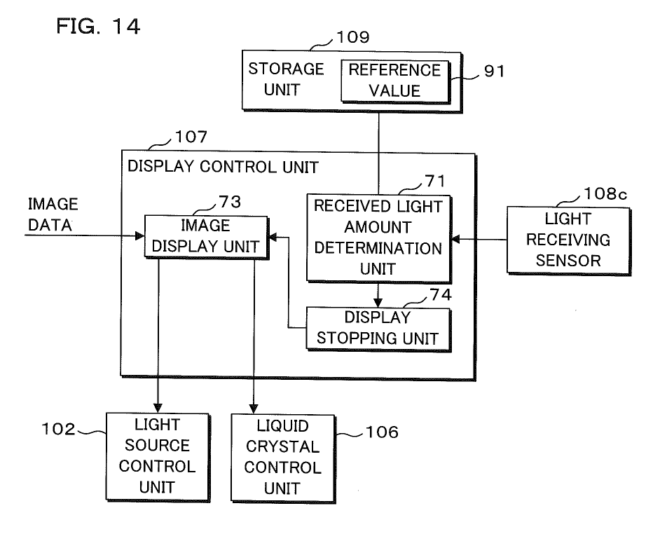

In Embodiment 2, the display control unit 107 controls display/non-display of the image depending on the presence or absence of the cover covering the pixel region 31, based on the received light amount data obtained from the light receiving sensor 108 of the central part disposed as illustrated in FIG. 13. FIG. 14 is a functional block diagram illustrating functions achieved by the display control unit 107 according to Embodiment 2. The display control unit 107 functions as the received light amount determination unit 71, the image display unit 73 and the display stopping unit 74. All functions thereof are basically equivalent to the functions described in Embodiment 1, and therefore, will be denoted by the same reference numerals, and will not be described in detail.

The received light amount determination unit 71 in Embodiment 2 receives the received light amount data from the one light receiving sensor 108 provided at the central part, determines whether the received light amount in the light receiving sensor 108 is the reference value 91 or less within the plurality of prescribed values stored in the storage unit 109, and outputs the determined result.

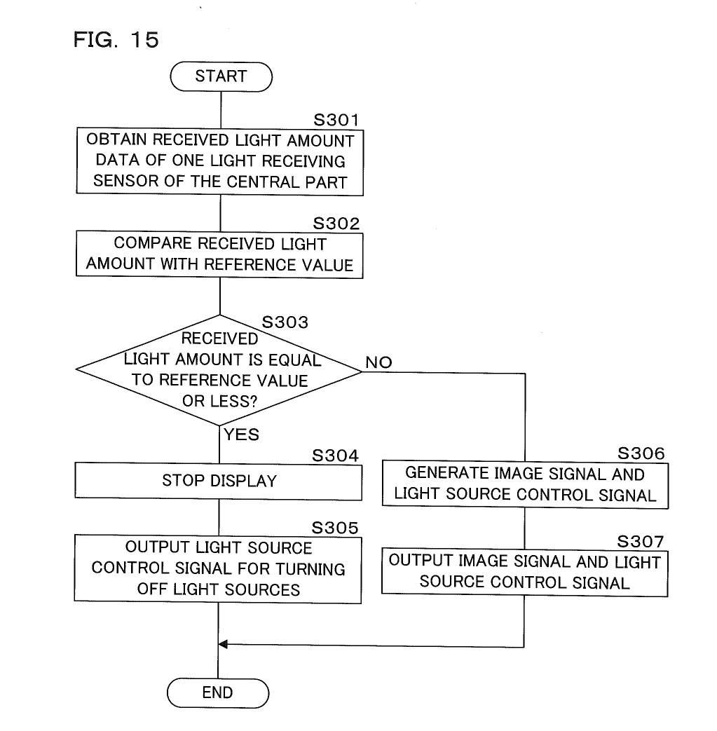

FIG. 15 is a flow chart illustrating an example of a processing procedure executed by the display control unit 107 of Embodiment 2. The display control unit 107 periodically repeats the processing illustrated below at a predetermined time interval such as 500 milliseconds, for example.

The display control unit 107 obtains the received light amount data of the one light receiving sensor 108 of the central part (step S301). The display control unit 107 compares the received light amount obtained based on the received light amount data with the reference value 91 stored in the storage unit 109 (step S302), and determines whether the received light amount is the reference value 91 or less (step S303).

In step S303, if it is determined that the received light amount is the reference value 91 or less (YES in S303), the display control unit 107 stops the display (step S304), outputs the light source control signal for turning off the light sources 111 (step S305), and ends the processing. In step S303, if it is determined that the received light amount is higher than the reference value 91 (NO in S303), the display control unit 107 generates an image signal for displaying the image based on the image data obtained from the control unit 11 and a light source control signal corresponding to the image signal (step S306), outputs the generated signals to the liquid crystal control unit 106 and the light source control unit 102, respectively (step S307), and ends the processing.

As illustrated in Embodiment 2, although the simple configuration in which one light receiving sensor 108 is provided at the central part, and the presence or absence of the cover covering the pixel region 31 is determined, when the covered region includes the central part, in particular, if it becomes a state of being difficult to view the image on the pixel region 31, the display of image is stopped. Thereby, misidentifying the contents of the image may be prevented. Further, since the light sources 111 are turned off, it is possible to achieve the energy conserving by appropriately controlling the display.

### Embodiment 3

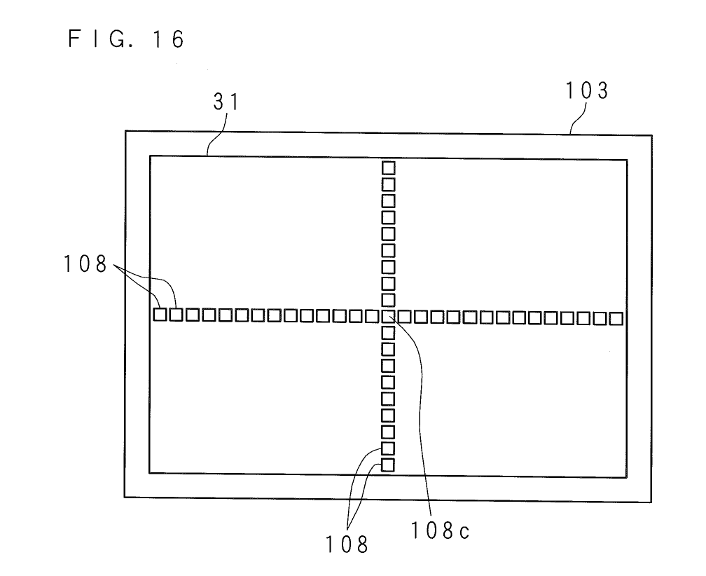

FIG. 16 is an explanatory view schematically illustrating an arrangement example of the plurality of the light receiving sensors 108 according to Embodiment 3. FIG. 16 illustrates the front of the liquid crystal panel 103. As illustrated in FIG. 16, the plurality of the light receiving sensors 108 are disposed in a cross shape passing through the vicinity of the center of the pixel region 31.

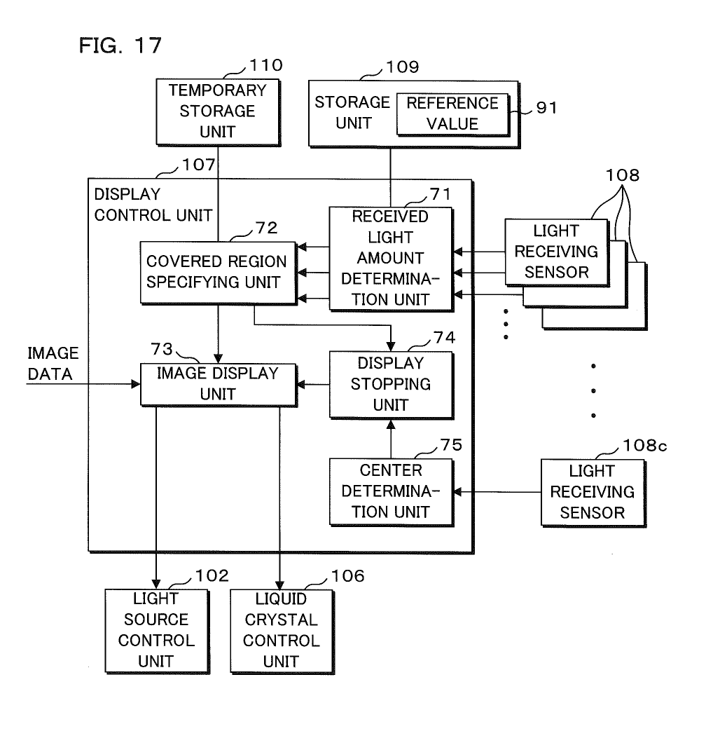

In Embodiment 3, the display control unit 107 controls to display the image in the remaining part outside the covered region depending on the presence or absence of the cover covering the pixel region 31, based on the received light amount data obtained from the light receiving sensors 108 and 108c which are disposed as illustrated in FIG. 16, and controls to stop the display when the central part is covered. FIG. 17 is a functional block diagram illustrating functions achieved by the display control unit 107 according to Embodiment 3. The display control unit 107 functions as the received light amount determination unit 71, the covered region specifying unit 72, the image display unit 73, the display stopping unit 74, and a center determination unit 75. Since the basic functions of the received light amount determination unit 71, the covered region specifying unit 72, the image display unit 73, and the display stopping unit 74 are the same as the functions described in Embodiment 1, and therefore, will be denoted by the same reference numerals, and will not be described for the basic functions in detail.

The covered region specifying unit 72 of Embodiment 3 determines whether the position of the plurality of the light receiving sensors 108 for which it has been determined that the received light amount is the reference value 91 or less on the corresponding pixel region 31, forms a part of a continuous planar region, and estimates and specifies the covered region. If it is determined that the received light amount in the light receiving sensors 108 corresponding to the position continued in a longitudinal direction or a lateral direction is the reference value 91 or less, the covered region specifying unit 72 specifies the covered region. The covered region specifying unit may be configured to determine whether the outline of the shape of the estimated covered region includes the linear outline, or whether the covered region includes the outer edge of the pixel region 31, so that it is possible to accurately determine the presence or absence of the cover.

The display stopping unit 74 of Embodiment 3 determines whether to stop the display based on the results of processing in the covered region specifying unit 72 and the center determination unit 75. Specifically, if it is determined that the received light amount in the light receiving sensor 108 of the central part is the reference value 91 or less by the center determination unit 75, and the covered region is specified by the covered region specifying unit 72, the display stopping unit stops the display.

The center determination unit 75 determines, for only a light receiving sensor 108c provided at the central part, whether the received light amount based on the received light amount data is the reference value 91 or less when it is compared with the reference value 91, and outputs the determined results to the display stopping unit 74.

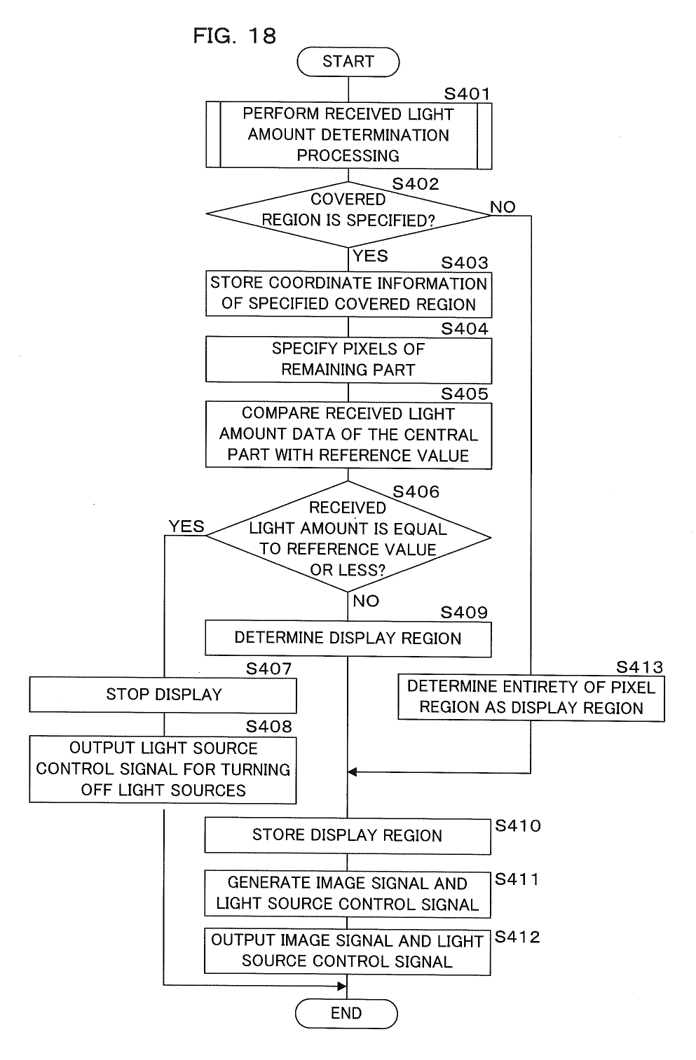

An example of a processing procedure when providing the light receiving sensor 108c of the central part and the other plurality of the light receiving sensors 108 as illustrated in FIG. 16 will be described. FIG. 18 is a flow chart illustrating an example of the processing procedure executed by the display control unit 107 of Embodiment 3.

The display control unit 107 periodically repeats the processing illustrated below at a predetermined time interval such as 500 milliseconds, for example.

The display control unit 107 performs the received light amount determination processing (step S401), and thereby, the positional information of the light receiving sensors 108 for which it has been determined that the received light amount is the prescribed reference value 91 or less is temporarily stored in the temporary storage unit 110. Further, the details of the received light amount determination processing in step S401 may be any one of the processing procedure illustrated in the flow chart of FIG. 8, and the processing procedure illustrated in the flow chart of FIG. 12.

The display control unit 107 determines whether the covered region is specified based on the positional information group stored in the temporary storage unit 110 (step S402).

If it is determined that the covered region is specified (YES in S402), the display control unit 107 stores the coordinate information of the specified covered region in the temporary storage unit 110 (step S403), and specifies the pixels of the remaining part based on the coordinate information stored in the temporary storage unit 110 (step S404).

The display control unit 107 compares the received light amount based on the received light amount data in the light receiving sensor 108 provided at the central part with the reference value 91 (step S405), and determines whether the received light amount is the reference value 91 or less (step S406). If it is determined that the received light amount is the reference value 91 or the less (YES in S406), the display control unit 107 stops the display (step S407), outputs the light source control signal for turning off the light sources 111 (step S408), and ends the processing.

In step S406, if it is determined by the display control unit 107, that the received light amount is higher than the reference value 91 (NO in S406), the display control unit 107 determines the display region including a part and/or all of the pixels of the specified remaining part (step S409), stores the determined display region in the temporary storage unit 110 (step S410), generates an image signal for displaying an image on the basis of the image data obtained from the control unit 11 and the light source control signal corresponding to the image signal (step S411), outputs the generated signals to the liquid crystal control unit 106 and the light source control unit 102, respectively (step S412), and ends the processing.

In step S402, if it is determined that the covered region is not specified (NO in S402), the display control unit 107 determines the entirety of the pixel region 31 as the display region (step S413), and progresses the processing to step S410.

Thereafter, the display control unit 107 either continuously turns off the light sources 111 by stopping the display until the processing from steps S401 to S413 are performed, or continuously generates and outputs the image signal based on the image data output from the control unit 11, so as to display the image in the determined display region.

As illustrated in Embodiment 3, when the central part of the pixel region 31 is covered by the cover, the display itself is stopped, such that the image or the related information is displayed in the remaining part of the narrow range, and thereby causing the misidentification may be prevented. Further, by the control of turning off or darkening the light sources 111, it is possible to achieve the energy conserving of the light sources 111.

Furthermore, the display control unit 107 may be configured so as to perform the determination in the display stopping unit 74 by using only the received light amount in the light receiving sensor 108c of the central part, or by combining the received light amount in the plurality of light receiving sensors 108 in the vicinity of the central part including the light receiving sensor 108c. Furthermore, the arrangement of the plurality of light receiving sensors 108 is not limited to the cross-shaped arrangement illustrated in FIG. 16, and various arrangements such as a Z shape, or zigzag shape may be considered.

In the above-described Embodiments 1 to 3, the configurations, in which the present invention is applied to the information processing apparatus 1 which is a tablet type PC, and the information processing apparatus 1 is placed on the desk, for example, and when the pixel region is covered by an object placed thereon, the image display is appropriately controlled, has been described. However, of course, the present invention is not limited thereto. For example, in not only the equipment including the display so as to be used by placing on the desk as the tablet type PC, but also the display apparatus which is erected upright with leg parts, it is possible to achieve an appropriate display when the cover is present on the pixel region.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

1-5. (canceled)

6. A display apparatus comprising:
a pixel region including a plurality of pixels;
a cover determination unit determining whether a cover covering a central part of the pixel region, or a cover covering a region of a prescribed ratio or more is present, during displaying an image in the pixel region; and
a display stopping unit stopping the display of the image if it is determined that the cover is present by the cover determination unit.

7. A display apparatus comprising:
a pixel region including a plurality of pixels;
a light receiving sensor provided at a central part in the pixel region to receive environmental light and output received light amount data;
a received light amount determination unit determining whether each received light amount in the light receiving sensor is a prescribed value or less based on the received light amount data output from the light receiving sensor; and
a display stopping unit stopping the display of the image if it is determined that the received light amount in the light receiving sensor is equal to the prescribed value or less by the received light amount determination unit during displaying an image in the pixel region.

8. A display apparatus comprising:
a pixel region including a plurality of pixels;
a plurality of light receiving sensors which are provided at positions different from each other in the pixel region to receive environmental light and output received light amount data;
a received light amount determination unit determining whether each received light amount in the plurality of light receiving sensors is equal to a prescribed value or less based on the received light amount data respectively output from the light receiving sensor; and
a display stopping unit stopping the display of the image if it is determined that the received light amount in a prescribed number or more of the light receiving sensors of the plurality of light receiving sensors is the prescribed value or less by the received light amount determination unit during displaying an image in the pixel region.

9. The display apparatus according to claim 6, further comprising:
a transmissive liquid crystal panel provided with the pixel region;
a light source device irradiating a rear surface of the liquid crystal panel with flat light;
a light amount control unit controlling an amount of light from the light source; and
a liquid crystal driving unit driving liquid crystal in the liquid crystal panel so as to correspond to the plurality of pixels,
wherein
the light amount control unit decreases the amount of light in an entirety of the pixel region if the display is stopped by the display stopping unit.

10. The display apparatus according to claim 8, wherein
the light receiving sensors are juxtaposed in a lattice shape within the pixel region.
